(19) United States
(12) Patent Application Publication
(10) Pub. No.: US 2023/0368155 A1
(43) Pub. Date: Nov. 16, 2023

(54) Runway Maintenance Apparatus

(71) Applicant: ROBOXI AS, Sandnes (NO)

(72) Inventors: Ken Erik Steine, Hafrsfjord (NO); Kristoffer Sorstronen, Stavanger (NO); Magnus Olsen Finnesand, Bryne (NO)

(73) Assignee: ROBOXI AS, Sandnes (NO)

(21) Appl. No.: 18/027,016

(22) PCT Filed: Sep. 17, 2021
(86) PCT No.: PCT/EP2021/075717

§ 371 Date: Mar. 17, 2023

(30) Foreign Application Priority Data
Sep. 17, 2020 (GB) 2014655.1

(51) Int. Cl. G06Q 10/20; B64F 1/36; E01B 25/30; G01S 17/88; G01J 5/00

(52) U.S. Cl. CPC G06Q 10/20; B64F 1/36; E01B 25/305; G01J 5/007; G01S 17/88

(57) ABSTRACT

An aerodrome maintenance apparatus for monitoring runway and taxiway conditions and remotely reporting the status of the runway or taxiway. The apparatus comprises: a drive unit arranged to mount one or more rails to provide movement of the apparatus along the one or more rails; a detection unit comprising one or more sensors configured to detect one or more parameters of the runway or taxiway; and a communications unit arranged to transfer data derived from the detection unit from the apparatus to a remote server. The apparatus is arranged to advance along the one or more rails and transfer data representative of one or more parameters of the surface to a remote server.

The present invention relates to an automated apparatus for monitoring and performing maintenance on airport runways and taxiways.

Maintenance of airport runways and taxiways is a major safety concern in airport operations. The conditions of a runway must be closely monitored to ensure that pilots and air traffic control are kept informed of the current runway conditions and are able to make decisions and adjustments necessary for safe flight operation.

For example, when adverse meteorological conditions cause the runway surface to be wet or icy, a runway friction measurement must typically be carried out to advise pilots and air traffic control of the reduced control and braking power on the runway surface. Other runway conditions, such as runway visibility (RVR) and wind speeds must also be measured. Such measurements can be slow and labour-intensive.

Another major issue which affects airports is build-up of rubber on the runways. When an aircraft lands on a runway, the landing gears experience a substantial frictional force from the ground which causes the rubber on the tyres to polymerize and adhere to the runway surface. As the rubber from landing aircraft accumulates over time, the frictional coefficient of the runway surface becomes diminished, resulting in critical loss in braking and ground handling performance. Airport runways and taxiways must regularly be maintained to minimise the amount of accumulated rubber on the surface. In practice, such maintenance is expensive and time consuming.

A further safety concern is that of foreign object debris (FOD) on the surface of runways and taxiways. Objects on the ground surface, including debris from vehicles, broken equipment and in some cases animals such as birds and rodents, can adversely affect fast-moving aircraft. Taxiway and Runway FOD can cause many serious problems, such as tyre puncture, injury to personnel and path blockage. When ingested in a jet engine for example, FOD can cause serious and substantial damage, often leading to deadly engine failures. Foreign object damage is typically mitigated by performing regular and frequent inspection of the airfield by airport staff. In such inspection operations, vast areas across the runways and taxiways must be swept and closely inspected for FOD, which can often be a lengthy and laborious process, as the airfield must be physically traversed.

The deployment of airport staff to monitor runway and taxiway conditions, manually taking measurements and reporting back to air traffic control, is unreliable, expensive and time-consuming. The problem is exacerbated when adverse conditions on the runway or taxiway are discovered and maintenance staff, together with specialist maintenance equipment, has to be deployed.

There is therefore a need for a solution which allows conditions on the runways and taxiways to be efficiently monitored and maintained.

### SUMMARY OF THE INVENTION

According to a first aspect there is provided an aerodrome maintenance apparatus for monitoring runway and taxiway conditions and remotely reporting the status of the runway or taxiway, the apparatus comprising: a drive unit arranged to mount one or more rails to provide movement of the apparatus along the one or more rails; a detection unit comprising one or more sensors configured to detect one or more parameters of the surface of the runway or taxiway; and a communications unit arranged to transfer data derived from the detection unit from the apparatus to a remote server, wherein the apparatus is arranged to advance along the one or more rails and transfer data representative of one or more parameters of the surface to a remote server.

The apparatus according to the first aspect is able to advance along rails installed on the aerodrome ground surface to navigate and traverse the surface, or alongside the surface, collecting, via the detection unit, data relating to runway and taxiway conditions. The data can be transferred, via the communications unit, to a remote server for example, where the data may be processed or interpreted and passed on to air traffic control, for example. By having an apparatus with the capability to advance along rails and gather aerodrome data, pilots and air traffic control are able to reliably stay updated with the condition of the runways and taxiways. Furthermore, the apparatus is able to detect irregularities such as cracks on the runway and trespassing wildlife, and alert the pilots or air traffic control. In some cases, as described below, those irregularities can be dealt with by the apparatus to ensure safe operation of the aerodrome. Such an approach removes the need for the laborious process of a manned vehicle being deployed, manually taking measurements and communicating manually the status of the runway. The data collected by the apparatus may include, or be associated with, location information. In particular, each data point collected by the apparatus may be linked with location data which represents the geographical location at which the data point was collected. The data relating to the runway collected by the apparatus may be used to generate or update a mapping of the information with respect to the location around the runway. Preferably, a pre-generated map may be stored in memory on-board the apparatus and each data point collected by the apparatus may be mapped on to the pre-generated map using the location data which is associated with that data point.

Whilst the data unit may comprise any suitable means for providing movement of the apparatus along the rails, typically the drive unit may comprise one or more wheels arranged to provide or assist rolling motion of the apparatus along the one or more rails. Each of the one or more wheels may be powered by one or more motors on-board the apparatus. Alternatively or in combination, the drive unit may comprise a maglev module arranged to provide magnetic levitation of the apparatus against the one or more rails. The drive mechanism may also comprise a winch, arranged to engage a guide rope provided on the one or more rails to provide motion of the apparatus with respect to the one or more rails.

The apparatus may be mounted securely on the rails to prevent accidental derailment. The drive mechanism may comprise a clamp for engaging the one or more rails so as to lock the apparatus engaged in contact or proximity with the one or more rails.

Movement of the apparatus, through operation of the drive unit, may be manually controlled. For example, the apparatus may be remotely controlled by a remote controller. The remote controller may be operated by a human or machine having knowledge of the surroundings and planned actions of the apparatus. Alternatively, the apparatus may have an on-board sensor. The detection unit may comprise a terrain sensor operable to scan and detect terrain surrounding the apparatus.

The terrain sensor may comprise a Lidar module, having a rotating laser beam arranged to illuminate surrounding terrain and provide a measure of distances between the apparatus and surrounding obstacles. The Lidar module allows the apparatus to autonomously compute a real time 3-D representation of its surroundings. The terrain sensor may comprise an optical light camera. The optical light camera may be arranged and oriented to capture still or moving images of the terrain surrounding the apparatus. The images from the camera may be processed on-board the apparatus, or transmitted to the remote server where the images can be processed or analysed.

Such a terrain sensor may be used to remotely gather information about the conditions surrounding the apparatus, which can be transmitted back to the remote server. The terrain sensor may comprise a LIDAR module arranged to scan and detect the surroundings of the apparatus, and output data representative of the surroundings of the apparatus.

The communications unit may comprise any suitable means for transmitting data from the apparatus to an external server. For example, the communications unit may comprise a transceiver arranged to wirelessly transfer data between the apparatus and the remote server. Such a transceiver may also be configured to wireless transfer data between the apparatus and the rail. Alternatively, or in combination, the communications unit may comprise electrical contacts or other means to allow data to be transferred directly from the apparatus to the rails on which the apparatus is mounted. The communications unit of the apparatus may then be arranged to transfer data between the apparatus and the remote server by transmitting signals through the rails on which the drive unit is mounted.

The apparatus may be equipped with a radar transmitting and receiving module, to allow the apparatus to communicate with air traffic control and with pilots of nearby aircraft. The radar transmitting and receiving module may utilise the communications unit, particularly a transceiver of the communications unit.

In some cases it may be particularly advantageous to provide a means for manual control of the apparatus. The transceiver of the communications unit may be operable to receive instruction information from a remote server. The communications unit may be arranged, in use, to communicate the instruction information to one or more of the drive unit and the detection unit. This allows the drive unit and the detection unit to be remotely operated from a remote server, to provide explicit control of the apparatus. In other examples, a period or scheduled operation may be used. For example, the apparatus may store within its on-board memory a preconfigured time schedule for traversing along selected regions of the rails. A typical process may be to first wake-up, traverse the runway along a particular length or distance whilst scanning and gathering data, and then power down once a predetermined position or time is reached.

The apparatus may advantageously comprise one or more measurement instruments for collecting data relating to runway conditions.

For example, the one or more sensors of the detection unit may comprise a friction meter arranged to measure and output data representative of a friction level of the surface. With a friction meter on-board, the apparatus is able to take measurements of the runway or taxiway surface and provide pilots and air traffic controllers with an accurate representation of the surface slipperiness which allows them to assess braking power and equipment controllability on the runway and taxiway surface.

Whilst the friction meter may employ any suitable method of measuring friction, the friction meter may comprise a friction measurement wheel arranged, in use, to be in contact with the surface of the runway or taxiway of the aerodrome. The friction measurement wheel may typically be deployed while the apparatus is in motion, and made to come into contact with the ground to produce rotational movement of the wheel. The rotational movement of the friction measurement wheel may be used to calculate a friction level of the surface. The friction level of the surface may be represented by a coefficient of friction, µ.

Alternatively, or in combination, the friction meter may comprise an optical module arranged to provide a measurement of the runway surface friction. Preferably the optical module may comprise an infrared source. The optical source may be configured to transmit radiation directed to the runway surface, to be reflected back to the apparatus and detected by a sensor or detector on-board the apparatus. The optical source may be a laser source.

The detection unit may further comprise an FOD sensor arranged, in use, to detect the presence of foreign object debris, FOD, on the surface. By equipping the apparatus with an FOD sensor it is possible to provide an efficient way of monitoring the presence of FOD on the runways and taxiways. When FOD is detected by the apparatus, data representative of the FOD may be transmitted to the remote server, such that the pilots and air traffic control can be made aware of the hazard. A remotely operated apparatus with FOD sensing capabilities ensures safe operations on the aerodrome without the need for deploying manned sweepers. The FOD sensor may comprise any one or more sensors selected from the group comprising: an x-ray sensor, a visible light sensor and a metal detection sensor. The FOD sensor may be configured to survey the ground surface of the runway or taxiway. This can be achieved for example by having the FOD sensor oriented towards the surface. Anomalies on the surface may be detected automatically by the apparatus, or by a human observer surveying data from the FOD sensor.

The apparatus may be arranged to provide a measurement of the visual range at the aerodrome. Typically, the apparatus may be configured to measure a runway visual range (RVR). That is, the distance over which a pilot of an aircraft on the centre line of a runway can see the runway surface markings or the lights delineating the runway or identifying the centre line. The detection unit may comprise a transmissometer operable to measure an ambient attenuation of light and output data representative of runway visibility. The detection unit may alternatively comprise a scatter meter operable to measure the RVR. In other examples, an on-board optical camera may be utilised to allow a human observer measurement of RVR. By being equipped with means for measuring visibility, the apparatus can provide an efficient way of remotely measuring visibility on the aerodrome. The transmissometer may be mounted on the apparatus via a gyroscope, or a gimbal, to stabilise the orientation of the transmissometer even while the apparatus is in motion.

The apparatus may comprise one or more fire detectors. Fires on the runways and taxiways present another major hazard in aerodrome safety. The detection unit may comprise a fire detector having an infrared sensor arranged, in use, to monitor ambient thermal radiation and detect fires. Alternatively, the fire detector may comprise a smoke detector, flame detector, or any other means of detecting the presence of a fire in the aerodrome.

Having detected the presence, or absence, of an anomalous condition from the detection unit, the apparatus may typically be operated in response to that detection. Preferably, the drive unit is arranged, in use, to autonomously effect movement of the apparatus based on data derived from the detection unit. The apparatus may have the capability to autonomously advance across the rails proximate the runways and taxiways of the aerodrome, find and report potential hazards or anomalous conditions and move towards the source of those conditions if required. This significantly improves efficiency of runway monitoring and maintenance operations.

The detection unit may comprise a runway light detector, arranged to detect the presence of runway lights and check the proper functioning of lights on the runway. The detection and checking of the proper functioning of lights may be effected by measuring the luminosity of a region where a runway light is expected and/or detected. Based on the measured luminosity, the proper functioning of the runway light can be checked - for example by checking whether the luminosity exceeds a threshold value or by comparison with historical data.

The apparatus may further comprise a maintenance unit arranged, in use, to perform maintenance operations on the surface of the runway or taxiway of the aerodrome. In addition to the ability to detect and report hazards on the aerodrome runways and taxiways to a remote server, the apparatus itself may have the capability to perform maintenance operations.

The maintenance unit may comprise a rubber removal module arranged to direct removal of rubber from the surface. The rubber removal module allows the apparatus to deal with the problem of accumulation of rubber on the runways and taxiways from aircraft landing gears, thereby providing a remotely operated solution. For example, the maintenance unit may direct a manually controlled or automated vehicle to the location of the rubber and control its removal.

A vehicle so directed may employ any suitable approach for removing accumulated rubber, typically, the vehicle may comprise one or more of: a high-pressure water module comprising a water storage tank and a high-pressure nozzle operable to output a jet of high pressure water to the surface; a chemical removal module comprising a chemical storage tank and a chemical applicator operable to apply a removal chemical into the surface; an impactor arranged, in use, to blast high-velocity abrasive particles at the surface; and a mechanical remover comprising a cutter arranged, in use, to mill a layer from the surface.

Whilst the vehicle may be operated manually, the removal module may be arranged to also operate when the apparatus detects the presence of rubber on the runway or taxiway. Typically, the rubber removal module may be arranged to conduct removal of rubber from the surface according to a measured surface friction level from the detection unit.

Once the rubber is removed from the surface, the rubber may be swept to one side, or collected for temporary storage. The vehicle may therefore comprise a sweeper. The sweeper may comprise a brush or any other means for effectively sweeping debris along, or away from, the surface. Alternatively, or in combination, the vehicle may comprise a storage tank. The storage tank may be housed internal to the volume, or external to the volume. The vehicle may further comprise a high-powered suction module operable to provide suction to collect debris from the surface into the storage tank. The storage tank may be used to store debris collected by the apparatus. One or more of the enclosing walls of the storage tanks may comprise an inspection window. The inspection window may comprise a transparent or translucent window to allow inspection of the contents of the tank from outside. The storage tank may comprise a sensor arranged to detect and notify when the tank is full.

Similar to the removal of rubber from the surface, the collection of debris can be directed manually or autonomously by the apparatus. Preferably, the maintenance unit may be arranged to conduct removal of rubber or collection of debris from the surface according to data derived from an FOD sensor in the detection unit. A vehicle, so directed, may utilise a high-powered suction module to collect debris from the surface. Alternatively, a debris collection module may comprise a magnetic collector, operable to collect debris from the surface. In some situations, a bolt or other mechanical component can come loose from an aircraft or other equipment, and become FOD on the runway. When the apparatus detects such loose components, the magnet can be operated to collect the bolt or component as the apparatus approaches near it. Alternatively, the magnet can be a permanent magnet or a constant electromagnet, such that metallic FOD can be collected even when undetected, as the apparatus drives near it.

The maintenance unit may further comprise a wildlife repeller arranged, in use, to repel wildlife proximal to the surface. The repeller may comprise one or more of: a laser source operable to emit a laser light; a speaker operable to emit a high-frequency sound; and a spray nozzle operable to output a spray of wildlife repelling chemicals. As discussed above, another major issue in aerodrome safety is the interference of flight operations by wildlife, such as birds, on the runway and taxiways. By providing a means of driving away wildlife, the apparatus can reduce the risk of interference with flight operations such as birds in the jet engine - known as bird strikes. By providing this facility on a moving apparatus, the repelling means can be moved towards the wildlife to better effect dispersal, compared to static repellers. Any laser units installed on the apparatus may be mounted on the apparatus via a gyroscope, or a gimbal, to stabilise the orientation and output beam of the laser even while the apparatus is in motion over rough or smooth terrain.

The laser source of the maintenance unit may also be operable as a laser source of a transmissometer operable to measure an ambient attenuation of light and output data representative of runway visibility.

The maintenance unit may further comprise a fire extinguisher, comprising an extinguishing agent tank and an extinguisher nozzle, operable to controllably release an extinguishing agent from the extinguishing agent tank. The fire extinguisher may be arranged to actuate the release of extinguishing agent from the extinguishing agent tank according to data derived from an infrared sensor in the detection unit. Such an arrangement allows the apparatus to autonomously detect a fire, approach the fire and extinguish the fire by releasing extinguishing agent from the extinguishing agent tank.

Whilst the apparatus may be powered by any suitable means, typically the apparatus comprises a power unit having a rechargeable power source. The rechargeable power source may be charged by a cable connection, induction charging or any other suitable means. Preferably, the apparatus may comprise a solar panel module, arranged to harvest solar energy and provide, in use, charge to the power source. The apparatus may comprise means for receiving power from the rails on which it is mounted. This can be achieved for example by having a power receiving module on the apparatus. For example, such a power receiving module may comprise electrical contacts arranged to contact conducting a surface(s) on the rail, through which power can be transferred. In another example, the power receiving module may comprise an induction coil arranged to receive power through inductive charging from the rail or a charging station mounted on or near the rail.

Preferably the apparatus comprises two or more of the above detection or maintenance unit functionalities.

According to a second aspect, there is provided a rail for mounting a runway maintenance apparatus, the rail comprising: a mount arranged to engage a drive unit of a runway apparatus; a support frame to fix the rail in place on or near a runway or taxiway surface.

The rail may be installed above ground or embedded within the ground. That is to say, in the former case, the support frame me be arranged to prop the rail up at a first distance from the surface, and in the latter case, the support frame may be arranged to embed the rail in the surface. Both cases have their benefits. For example, by having the rail installed above ground, the visibility of rail and its presence on the runway is improved. Having the rail installed in the ground can be advantageous as the top of the rail can be made flush with the ground surface, such that aircraft can easily pass over the rail. This would allow the rail to be installed across the full length of the runway and allow intersections with taxiways without disturbing aircraft passage. In some examples, the rail may comprise a mixture of above ground and below ground support frames.

The rail may comprise a heatable element, arranged to receive thermal energy from a heat source so as to transfer heat to outer surfaces of the rail. The heat source may be connectable to an electrical power source to conver the electrical energy into thermal energy for use by the heatable element. This can be particularly beneficial in the winter or in frosty climates, where rails can be prone to ice build-up, which can present a hazard. The heatable element can be used to remove the ice and ensure safe operation of the apparatus.

The rail itself may comprise an FOD sensor, arranged to detect the presence of foreign object debris, FOD, on the rail. The FOD sensor may comprise one or more of: a weight sensor, a pressure sensor, a visible light camera or an infrared camera. The rail may comprise an FOD clearance module, arranged to remove FOD detected by the FOD sensor from the rail. The rail may further comprise a washer, arranged to clean the surface of the rail.

According to a third aspect, there is provided a system for aerodrome maintenance comprise an apparatus according to the first aspect mounted on a rail according to the second aspect. It will be understood that the various features and their associated advantages described above can equally be applied to the first and second aspects when integrated into the system according to the third aspect.

Aspects of the present invention, by utilising an autonomous or remotely controlled apparatus having detection, communication and maintenance capabilities, enables efficient monitoring and maintenance of airport runways and taxiways. One particular advantage of having a multifunctional airfield monitoring apparatus mounted on rails installed on the airfield surface is that there is little to no risk of the apparatus going off course when patrolling and traversing the airfield surface. As such, the system enables the runway to be checked immediately prior to, or even concurrent with, the take-off or landing of an aircraft. For example, the apparatus can slide along the runway together with or immediately prior to the motion of an aircraft to measure and provide an accurate report of the runway conditions.

According to a fourth aspect, there may be provided a multifunctional aerodrome maintenance apparatus for monitoring runway and taxiway conditions and remotely reporting the status of the runway or taxiway, the apparatus comprising: a drive unit arranged to mount one or more rails to provide movement of the apparatus along the one or more rails; a multifunctional detection and/or maintenance unit configured to detect parameters of the surface of the runway or taxiway or perform maintenance operations on the runway or taxiway; and a communications unit arranged to transfer data derived from the detection unit from the apparatus to a remote server, wherein the apparatus is arranged to advance along the one or more rails and transfer data representative of one or more parameters to a remote server.

The multifunctional detection and/or maintenance unit may comprise a plurality of functional modules, each configured to perform a function of detection or maintenance on the surface of the runway or taxiway.

The multifunctional detection and/or maintenance unit may be configured to perform any two or more of the detection or maintenance operations described above.

The multifunctional detection and/or maintenance unit may be comprise two or more selected from a group comprising:
a laser, sound, and/or thermal camera to find and scare wildlife;
a friction meter or infrared laser to measure friction on the surface of the runway or taxiway;
a LIDAR camera to detect foreign objects, FOD;
a camera to measure a strength of lights to detect defects;
a light washer to wash runway lights;
a camera technology to inspect pavement cracks for further analysis on when to improve the pavement;
visibility, air temperature and/or ground temperature sensors; and,
a thermal camera to map runway surface conditions.

### BRIEF DESCRIPTION OF DRAWINGS

An example aerodrome maintenance apparatus and rails for mounting such an apparatus will now be described by way of example with reference to the accompanying drawings, in which:

FIG. 1 schematically illustrates an example airport maintenance apparatus in an assembled configuration.

FIG. 2 schematically illustrates an example rail for mounting a runway apparatus, in an assembled configuration.

FIG. 3 illustrates an example airport maintenance apparatus and example rail for mounting the runway apparatus, in use on an aerodrome runway.

FIG. 4 illustrates an example airport maintenance apparatus and example rail for mounting the runway apparatus, in use on an aerodrome runway.

FIG. 5 schematically illustrates an example airport maintenance apparatus mounting an example rail.

### DETAILED DESCRIPTION

The following examples illustrate a typical implementation of an apparatus having runway and taxiway monitoring and maintenance capabilities.

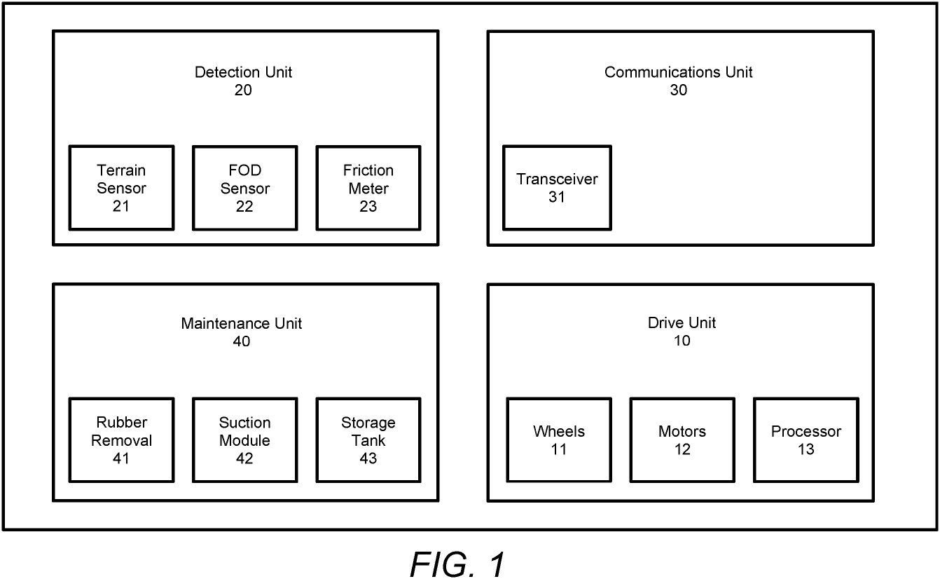

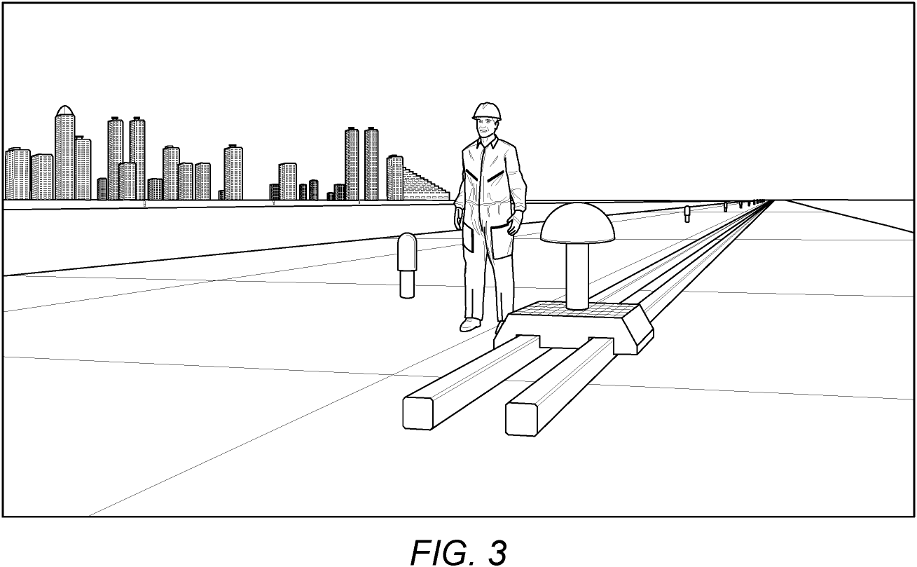

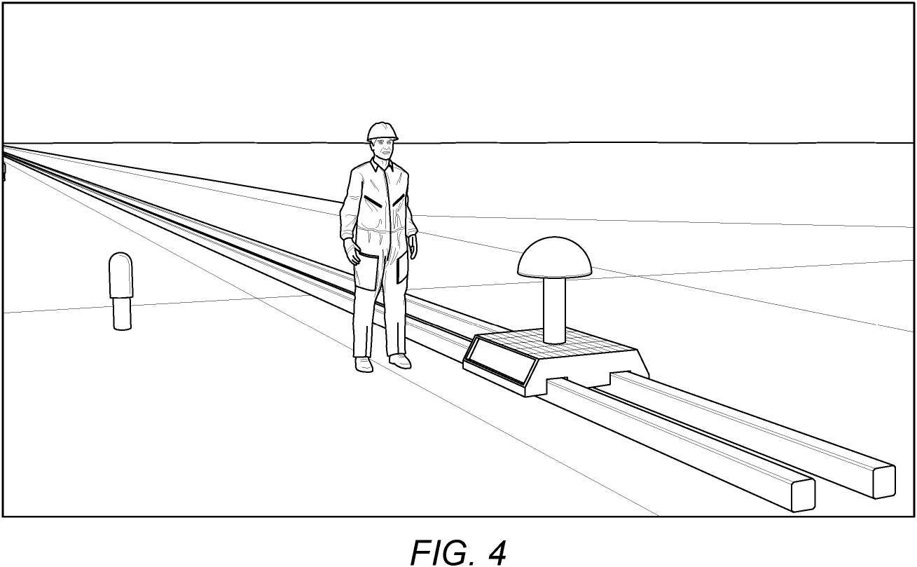

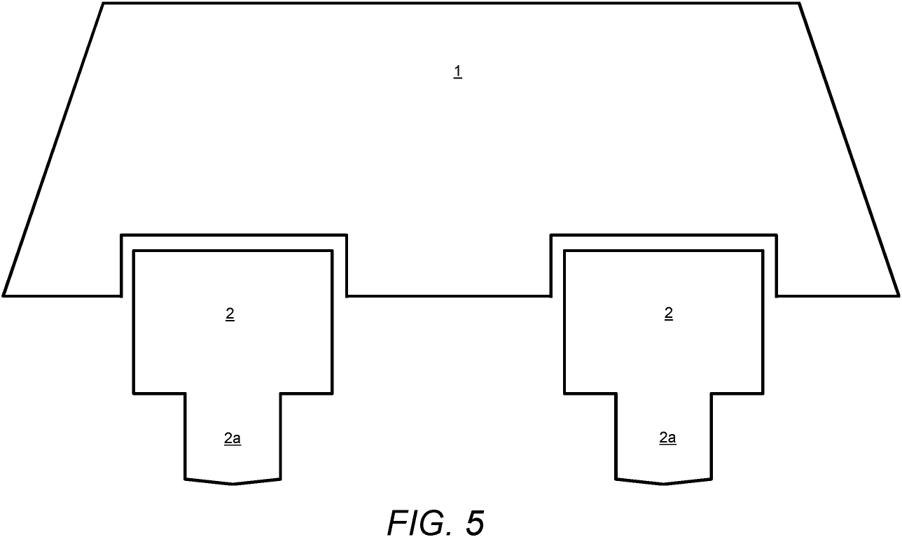

An example airport maintenance apparatus 1 is schematically illustrated in FIG. 1. The apparatus 1 comprises a drive unit 10, a detection unit 20, a communications unit 30 and a maintenance unit 40. The apparatus 1 is shown in FIGS. 3-5 mounting a rail 2, which will be described in more detail below.

The drive unit 10 comprises component parts required for motion of the apparatus 1. In this example, the drive unit 10 comprises a plurality of independent wheels 11, connected to one or more motors 12. The wheels are typically placed at a lower side of the apparatus 1 and are arranged to engage one or more surfaces of a rail 2 so as to provide motion of the apparatus 1 with respect to the rail 2.

In some examples, the drive unit 10 can also comprise a drive processor 13 configured to output a signal to the motors 12 and wheels 11. In some examples, the drive processor 13 is connected to the communications unit 30 to receive and transmit drive data, such as route information and location information. The drive unit 10 can also comprise a stabilising mechanism such as a variable suspension, so as to provide stability to the other components on-board the apparatus 1 when the apparatus 1 is in motion.

The drive unit 10 can be manually operated from a remote server (not shown in FIG. 1), to provide manual remote control over the position and movement of the apparatus 1. Alternatively, the drive unit 10 can be configured to operate autonomously. When operating autonomously, the motion of the apparatus 1 due to the drive unit 10 is dependent on a detected geography of the surroundings and of the condition or accessibility of rails 2 on the aerodrome surface. As such, the processor 13 of the drive unit 10 is typically connected to the detection unit 20.

The detection unit 20 comprises one or more sensors configured to detect one or more parameters of the ground surface. In one aspect, the detection unit 20 comprises a terrain sensor 21, operable to scan and detect terrain surrounding the apparatus 1. In this example the terrain sensor 21 comprises a Lidar module, having a laser source arranged to output a rotating laser beam. In use, the laser source emits a laser beam which is reflected back to the apparatus 1 by surrounding terrain and obstacles. The Lidar module measures the time taken to receive the reflected beam and calculates the distance to the nearest object or terrain in that direction. By performing such a calculation through all azimuthal angles, the Lidar module is able to output a 2-D or 3-D representation of its surroundings.

Data generated by the Lidar module can be processed, either on-board the apparatus 1 or by a remote server, to construct a real-time map of its surroundings. The data can also be used to update and maintain an existing map. The map generated and/or maintained by the apparatus can include the surrounding terrain and also any detected obstacles or vehicles on the terrain. The map can be updated to include information gathered by other components on-board the apparatus, such as the FOD detector or friction meter, as will be explained later. The apparatus 1 can also gather information about its surroundings off-ground, meaning that the apparatus 1 is capable of generating a map of the airspace near the apparatus 1. Information from the Lidar module can be passed from the detection unit 20 to other units such as the drive unit 10 or the communications unit 30.

In some examples, the detection unit 20 comprises a visible light camera comprising an optical sensor arranged to capture a still or moving image of the surroundings. The visible light camera therefore provides visibility of the surroundings of the apparatus 1. The camera can be arranged to detect surrounding terrain for example, and data from the camera can be transmitted to the drive unit 10 which can direct and move the apparatus 1 in a direction according to the sensed terrain. Furthermore, images from the camera can be passed to the communications unit 30 to be transmitted to a remote server, as will be described below. The camera can utilise visible light sensors, infra-red sensors and the like, or combinations thereof.

One advantageous use of the camera on-board the apparatus 1 is for detecting the presence and proper function of lights on the runway. Faulty lights can be detected as a total (or periodic) absence of illumination or a decrease in (or insufficient) intensity of illumination from the runway light. The apparatus 1 can be made to patrol a specified length of rail 2 on the aerodrome runway or can be directed to a specific position on the rail 2 proximate to a specific region on the airfield, where the camera can detect the presence (or expected presence) of lights on the runway. The camera can then be used to check the proper function of the lights on the runway and when a faulty light is detected, this can be reported. In one example apparatus 1, the location of detected faulty lights is recorded and mapped so as to track the exact location of these faults. The apparatus 1 can then alert, for example via the communications unit 30, air traffic control to the presence of faults (the alert including the exact location of the faulty lights) so that the lights can then be duly fixed. As a mapping of the lights is maintained within the apparatus 1, the apparatus can periodically return to the recorded location of the faulty light to check whether or not the light has been fixed, and the efficacy of the repair (by measuring intensity of light, for example, before and after the repair). The data can be used by a processor, either on-board the apparatus 1 or remotely, to compare historic data to identify a change. The runway lights can therefore be tracked for proper function over time using a relatively simple system. Whilst the above example has been described using a visible light camera, the same principle can be applied using other means of light detection, for example by infrared camera.

In another advantageous use of the camera (or similar sensing component of the detection unit 20), the apparatus 1 can scan the runway surface for cracks in the surface. As the apparatus 1 travels along the rails 2 positioned on or near the runway, the camera can be used to monitor the runway surface for irregularities. When a crack in the runway surface is detected, the detection unit 20 can send a signal to an on-board processor or to a remote server to alert that a fault in the surface has been detected. The apparatus 1 can map the exact position of the fault by recording the data point against the location information.

While above we mentioned that any sensing apparatus may be used to generate the runway surface map, in preferable embodiments a thermal imaging sensor may be used to generate a map of the heat of the surface of the runway. Similarly, a distance sensor may be used to identify a distance between the surface and a fixed point on the vehicle representing an anomaly in the surface of the runway.

When a particular position on the runway surface is known to have a fault (e.g. a structural weakness, a crack or other irregularity), the apparatus 1 can be programmed to periodically move along the rail 2 to a position proximate to the location of the fault, take a picture with the camera and record the visual information obtained. The apparatus 1 can return to the same position and take a picture to record and observe the progress of the fault over time. Similarly, the runway surface maps identified above may be updated periodically or more frequently in identified fault areas. This can allow for example the apparatus 1 (or a person controlling the apparatus 1) to observe the development of the fault over time and monitor for the appearance of a potential hazard. By mapping the faults over time it is possible to have a real-time map of all of the potential faults or hazards on the runway surface. A map generated by data derived from measurements by the apparatus 1 can be used to compare to previous maps to spot any differences or changes in conditions. These changes can be alerted via the communications unit 30 to a user or remote server. In addition to faults in the runway surface, other properties of the runway can also be mapped - for example runway friction which, as described below, can be measured by the apparatus 1.

The detection unit 20 further comprises an FOD sensor 22. The FOD sensor 22 is arranged, in use, to detect the presence of FOD on the ground surface. In this example, the FOD sensor 22 comprises an x-ray camera. The x-ray camera comprises an x-ray sensor arranged to capture a still or moving image of the surroundings using x-ray radiation.

In addition to various optical and radiation detectors, the detection unit 20 can also comprise measurement instruments to perform physical measurements of various runway parameters. In this example the detection unit 20 comprises a friction meter 23. The friction meter 23 comprises a laser and sensor pair which are arranged to measure the surface friction using non-contact measurement techniques. In an example using a simple roughness measurement, the laser and sensor pair are arranged to measure for example the surface roughness (via distance-time measurements of reflected rays) and the measured roughness can be used to derive a surface roughness. In some cases an infrared source or camera can be used to provide non-contact temperature measurement techniques from which the surface friction can be derived. In other examples, more complex techniques can be employed to provide non-contact measurement of runway surface friction. For example the friction meter 23 can comprise an infrared sensor arranged to provide a measurement of surface friction. This can be achieved for example using the fact that most of the energy losses due to friction are released as heat energy. The infrared sensor can therefore be employed to measure the heat energy lost from a surface and, using a calibrated model for example, derive the surface friction level. The infrared sensor may comprise an infrared laser, stabilised on the apparatus 1 via a gimbal so as to allow the laser to be used without loss of alignment when the apparatus 1 is in motion. In use, the laser can provide a source of infrared (or otherwise) radiation to be reflected back to the apparatus. The infrared sensor can measure parameters relating to the reflected radiation (e.g. intensity) to generate the infrared sensor data. Data from the infrared sensor can be fed to the on-board processor, or sent to a remote server, where the data can be processed to derive the surface friction level. In other examples, the friction meter 23 can comprise a wheel that is arranged to come into contact with the ground surface, and travel alongside the apparatus as it glides along the rails 2. Such a measurement wheel can be provided on the apparatus via a retractable extending arm. In some examples, the apparatus 1 can comprise multiple technologies for measuring runway surface friction - for example both a measurement wheel 23a and an infrared laser source. The apparatus 1 may record measurements from both the wheel 23a and the laser simultaneously.

As well as the runway surface, the friction meter 23 can be arranged to measure/calculate the friction of the rail surface along with the apparatus 1 advances. This can be used to detect any anomalies in the condition of the rails 2 and can assist in gathering data about the ambient weather conditions. The apparatus 1 can be arranged to simultaneously measure the friction level along the rail surface and of the runway surface - for example by providing one laser source directed at the rail and one source directed at the runway surface, or by having one friction measurement wheel in contact with the rail (or indeed using one of the wheels of the drive unit 10 as a measurement wheel) and one friction measurement wheel in contact with the runway surface, or a combination of such arrangements. In some cases, the measured friction level of the rail can be used to normalize the measured friction level of the runway surface, or vice versa.

When a hazardous (low) level of friction is detected on a runway, for example due to the presence of ice or frosting on the runway surface, a chemical is normally applied to the runway surface to mitigate or counteract the lack of traction on the runway surface. In the case of ice on the runway, a de-icing chemical is normally applied by a runway chemical application vehicle. An existing problem in the art is that it is not always possible to know if a sufficient or excessive level of chemical has been applied to suitably deal with the hazard. In one example apparatus, the detection unit is provided with one or more chemical tracers for monitoring the amount of chemical applied to the runway surface. Typically, the chemical tracer comprises an infrared camera (or utilises an infrared camera of another component of the apparatus). Data derived from the chemical tracer, along with data derived from other components of the detection unit, for example the friction meter 23, can be processed by the on-board processor (or a remote server) to determine whether an appropriate amount of chemical has been applied to the runway surface. The measured levels of friction and levels of chemical applied to the surface can be compared with pre-recorded historical data which indicates the expected friction level for a given amount of applied chemical. If it has been determined that there is an insufficient amount of chemical applied (i.e. the runway is still too slippery after application of the chemical), then the apparatus can flag an alarm via the communications unit to alert air traffic control, for example. The apparatus 1 can be programmed to follow an airport runway chemical application vehicle so as to make measurements with the chemical tracer immediately following application by the application vehicle. In some examples the apparatus 1 itself can be arranged, through the maintenance unit 40, to apply the chemical to the runway.

In addition to the above functionality relating to friction measurement, or as an alternative, an infrared sensor on-board the apparatus can be arranged to detect levels of heat in the surroundings, for example to detect a fire in the airfield. For example, a set threshold temperature may be stored on the on-board processor (or on a remote server). If the data gathered by the infrared sensor exceeds the set threshold temperature value then the apparatus 1 can generate an alert to signal a potential fire. In some examples, when the apparatus 1 detects a potential fire the apparatus 1 carries out an action - for example move close to the fire by the drive unit 10 and extinguish the fire by on-board fire extinction functionalities in the maintenance unit 40 (described later).

In addition to the above functionalities, the detection unit 20 can also comprise functionality to detect chemical parameters on the runway. For example, contact and/or non-contact techniques can be employed to perform chemical analysis of the runway surface. The detection unit 20 can scan the runway surface, for example using a non-invasive technique such as by on-board camera, to provide data relating to the levels of a certain chemical on the surface. The data generated may relate to levels of complex chemical compounds, or simple structures such as water. Data generated by a chemical analysis module in the detection unit 20 can be sent to an on-board processor (or to a remote server) and the apparatus 1 can take action depending on the processed chemical analysis data. For example, in reaction to a detected low level of additive or chemical on a part of the runway surface, the apparatus 1 can apply a new layer of the required additive/chemical to that part of the runway surface.

Data from the detection unit 20 can be used to map aspects of the runway on which the apparatus 1 and rails 2 are deployed. For example, the terrain sensor 21 can be used to scan the surroundings of the apparatus 1 to generate a map (or alternatively a pre-generated map can be provided to the apparatus 1) and the FOD sensor 22 can be used to scan the surroundings of the apparatus 1 so as to map the location of any debris or obstacles on to the generated (or otherwise stored) map. The mapping can be done by an on-board processor, or alternatively the data gathered by the apparatus 1 can be sent to a remote server where the mapping can take place remote from the apparatus 1. The scanning described above can be done on an ad-hoc basis, or alternatively the apparatus 1 can be programmed or instructed to attend to particular locations on the runway (or to simply ‘roam’ or patrol all available regions of the runway where the rails 2 have been installed) to perform regular or scheduled scans of the local surroundings.

In one particularly advantageous example, at least a part of the detection unit 20 is provided as a module which is removably mounted to the surface of the apparatus 1. The module can for example be mounted on slidable rails provided on the surface of the apparatus 1. The module can be provided as a bar for example in which all, or some, of the components of the detection unit can be placed. The bar can then be mounted on the apparatus 1 such that it overhangs an edge - typically the front edge - of the apparatus 1. Sensors in the bar can be directed downwards towards the runway surface and arranged such that it has 360 degree line of sight around the apparatus 1.

Typically, the detection unit 20 provided on the apparatus 1 has a 360 field of view so. In one example apparatus, two or more detection units 20 can be installed on the apparatus 1. For example, one detection unit 20 can be placed at a front end of the apparatus - to check the status of the runway in front of the apparatus 1 - and a second detection unit 20 can be placed at a rear end of the apparatus. The detection unit 20 at the rear end of the apparatus can provide means to check the conditions of the runway at a later time. For example, the second detection unit 20 can be arranged to check how the apparatus 1 and its functions has changed the conditions of the runway once the apparatus has passed near a detected fault.

The detection unit 20 is connected to the communications unit 30 and the drive unit 10 such that data from the one or more sensors within the detection unit 20 can be passed to the communications unit 30 or the drive unit 10.

The communications unit 30 is arranged to handle the exchange of information to and from the apparatus 1. The communications unit 30 comprises a transceiver 31 arranged to communicate with a remote server. The transceiver 31 is typically arranged to transfer data derived from the detection unit 20 from the apparatus 1 to the remote server. The transceiver 31 is also arranged to receive information, such as movement instructions relating to the operation of the drive unit 10, data collection instructions relating to the operation of the detection unit 20 and maintenance information relating to the operation of the maintenance unit 40. Data from a remote server, received at the transceiver 31, is typically passed on to one of the drive 10, detection 20, or maintenance 40 units for specific action. Typically, the apparatus comprises a memory unit 50 arranged to allow temporary or permanent storage of data gathered by the apparatus 1 itself, or data communicated to the apparatus by a remote server. Data measured by the measurement unit 20 can be continuously recorded to the memory unit 50, and each new measurement made by the measurement unit 20 can be compared with historical data. The apparatus can take one of several actions based on the result of the comparison, such as raise an alarm, change the frequency of detection, or change the movement plan of the apparatus along the rails 2. In one example, when a measurement of friction is made at a particular position on the runway, the measured friction level can be compared with previous measurements of friction made at the same position. In another example, when assessing quality of the runway surface (e.g. checking for cracks or faults in the surface), each time a measurement or photo is taken of the runway quality in a given position, the measurement or photo can be compared with previous measurements or photos taken at the same position. If the comparison shows the development of a crack or fault in the runway surface, the apparatus can send an alert via the communications unit 30 to air traffic control. Historical comparisons can be made with respect to data stored on the memory unit 50 on-board the apparatus 1, or alternatively comparisons may be made with respect to data stored in the remote server.

The transceiver 31 can be arranged to provide long-range or short-range communication between the apparatus 1 and a remote server. For example, the transceiver 31 can be arranged to provide long-range radio communications. In other examples, the transceiver 31 is arranged to provide short-range communications using local area technologies such as Wi-Fi or Bluetooth.

In this example, the communications unit 30 further comprises a radar module 32 arranged to allow radar communication between the apparatus 1 and an external radar operator such as an air traffic control tower. Typically, the radar module 32 comprises a radio frequency transmitter and receiver. The radar module 32 allows the apparatus to communicate via radio waves to an external equipment or entity. This is particularly useful in airfields where radar transmission is often the main mode of communication between moving vehicles and air traffic control. Whilst the example shows the radar module 32 being a separate module to the transceiver 31, in some examples the transceiver 31 itself can be arranged to provide radar communications.

In some examples, the communications unit 30 comprises a screen to allow a nearby user to see information provided by the apparatus 1.

The maintenance unit 40 is arranged to allow the apparatus 1 to direct or perform various maintenance operations, typically in response to parameters observed by the detection unit 20, or in response to instructions from the communications unit 30.

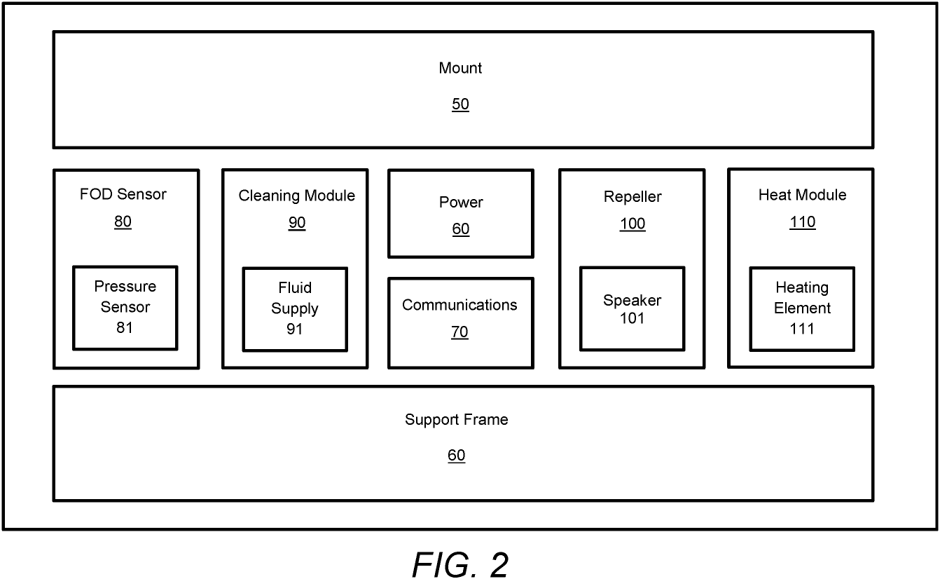

FIG. 2 schematically illustrates an example rail 2. The rail comprises a support frame 60 which supports a mounting portion 50. The mounting portion 50 is arranged to engage with the drive unit 10 of the apparatus 1 such that the apparatus 1 is able to move along the rail 2, either through contact movement or non-contact movement (e.g. maglev).

The key function of the rail 2 is to provide a fixed track along which the apparatus 1 can move or glide. Additionally, the rail 2 provides a number of optional but significantly advantageous features which assist the operation of the apparatus 1. The example rail 2 illustrated in FIG. 2 further comprises a power module 60, a communications module 70, a cleaning module 90, an FOD sensor 80, a repeller 100 and a heat module 110.

The power module 60 comprises means for delivering electrical power to the apparatus 1. Typically, this involves an electrical connection from an external power source which runs through the length of the rail 2. In some examples however the power source can be integrated within the rail 2 itself. In one example, the power module 60 comprises an electrical contact. The electrical contact can be integral with the surface of the rail (e.g. via an electrically conductive mount 50) or it can be a separate feature which can for example protrude from the rail 2 at certain points. Such an electrical contact on the rail 2 is arranged for engagement with a corresponding electrical contact on the apparatus 1 such that the apparatus 1 and rail 2 can be electrically connected through the contacts, and power can be transferred from the power source to the apparatus 1 to power the various functions of the apparatus 1.

In another example, the power module 60 of the rail 2 can be provided with an induction coil, which is arranged to engage with an induction coil on-board the apparatus 1 to provide electrical power to the apparatus 1 through inductive charging.

The power module 60 may be configured such that power can be delivered continuously to the apparatus 1 at all points along the rail 2 (e.g. by having an electrical contact or coil extend along the full length of the rail 2). Alternatively, multiple power modules 60 may be positioned at specified points along the length of the rail 2 such that the apparatus can be recharged at predetermined intervals as it moves along the rail 2.

As with the power module 60, the communications module 70 can be configured to transfer data between the apparatus 1 and the rail 2 using either, or a combination of, contact or non-contact techniques. The communications module 70 may comprise a wireless transceiver arranged to communicate with a transceiver on-board the apparatus 1 for data transfer.

In some examples, the power module 60 and communications module 70 can be one of, or part of, the same component. In the case that the power module 60 comprises electrical contacts, the communications module 70 may utilise the same connection to transfer the data. Similarly, in the case that the power module 60 utilises an induction coil to inductively charge the apparatus 2, the rail communications module 70 may utilise the magnetic connection to transfer data through electromagnetic pulses of the inductive coupling.

The FOD sensor 80 is arranged to detect unexpected objects which are present on the rail surface. For example, foliage, aircraft debris and other foreign objects may be present on the rail 2. If the apparatus 1 attempts to advance along the rail 1 when such FOD is present on the surface, there is considerable risk of significant damage to both the apparatus and the rail. Therefore it is important to sense the presence of such FOD on the rail 2. The FOD sensor 80 can be arranged to detect such debris for example by using a pressure sensor 81. The sensor 81 is arranged to monitor the pressure against the rail surface and if it exceeds a threshold value (taking into account the position of the apparatus 1), the sensor 80 is configured to output a signal indicating the possible presence of FOD on the rail surface 2. That signal can be transmitted via the communications module 70 to the apparatus 1 to be processed on-board or transmitted further to a remote server, or the signal may be sent directly along the rail to a remote server.

The cleaning module 90 is configured to maintain the rail surface in an operable condition. For example, the cleaning module 90 may comprise a fluid supply 91 and nozzles, arranged such that the nozzles direct cleaning fluid at or across the rail surface. The fluid can be ejected in a jet directed to the surface to remove dirt and soot built up on the rail surface. The fluid can be a lubricating fluid such that each clean of the rail also helps to improve the movement of the apparatus 1 along the rail 2. Furthermore, the cleaning module 90 can include means for expelling high pressure air from the surface of the rail 2 so as to remove lighter FOD such as stray foliage.

As noted above, wildlife can often traverse onto runways and taxiways which can cause problems for passing aircraft. As the rail 2 is configured to be installed on such runways and taxiways, it is possible that wildlife such as deer and birds can move onto the rails. Furthermore, airfield personnel are often required to traverse the runway. It is desirable to avoid the risk of the apparatus 1 crashing into wildlife or airfield personnel when gliding along the rails 2. The example rail 2 of FIG. 2 is equipped with a repeller 100 which is configured to repel wildlife and personnel from the rails 2. The repeller 100 comprises at least one speaker 101 which is positioned at specified points along the rail 2. The speaker is arranged to emit sounds to encourage wildlife and personnel to stay away from the rail 2. This can be done continuously, at a predetermined interval, or it can be done actively in response to a detection signal from the FOD sensor or from a dedicated sensor which detects wildlife and personnel in the vicinity of the rails 2. In some examples the apparatus 1 can detect the presence of personnel or wildlife and communicate the detection to the communication module 70 of the rail 2, in response to which the speaker 101 is activated to warn the wildlife and personnel away.

In extreme weather conditions, frost can build up on the rails which can be a significant safety hazard. The heat module 110 is configured to heat up sections of the rail 2 to melt any frost or ice on the rail surface. The module 110 comprises a heating element 111 which is connected to a power source, e.g. power module 60, and which can be activated to deliver heat energy to the surface of the rail 2. The heating element 111 can be operated manually by a user switch, or it can be programmed to activate when ice or frost buildup is detected. The heating element 111 can also be programmed to automatically switch on at certain time intervals when a detected temperature falls below a threshold value.

In use, the apparatus 1 mounts the rail by engaging the drive unit 10 with the mount of the rail 2. Such a configuration can be seen in FIGS. 3-5. In these examples the apparatus is shown mounting two rails 2 which are supported from the ground with support frames 2a. In other examples, the apparatus 1 may be configured to mount only a single rail 2, or any other number of rails 2, and the rails 2 may be embedded within the ground using support frames 2a arranged to hold the rails 2 within the ground.

In this example, the rails provide power to the apparatus through electrical contacts on the apparatus and conductors on the rail surface. Through use of the drive unit 10, the apparatus moves along the rails across the airfield to traverse the runways and taxiways collecting data. The detection unit 20 is activated to measure runway surface friction, presence of FOD and the like. Data collected by the apparatus 1 is the sent to a remote server through the rails 2.

In examples of the present disclosure there may be provided an aerodrome maintenance apparatus for monitoring runway and taxiway conditions and remotely reporting the status of the runway or taxiway, the apparatus comprising: a drive unit arranged to mount one or more rails to provide movement of the apparatus along the one or more rails; a detection unit comprising one or more sensors configured to detect one or more parameters of the runway or taxiway; and a communications unit arranged to transfer data derived from the detection unit from the apparatus to a remote server, wherein the apparatus is arranged to advance along the one or more rails and transfer data representative of one or more parameters of the surface to a remote server.

1. An aerodrome maintenance apparatus for monitoring runway and taxiway conditions and remotely reporting the status of the runway or taxiway, the apparatus comprising:
a drive unit arranged to mount one or more rails to provide movement of the apparatus along the one or more rails;
a detection unit comprising one or more sensors configured to detect one or more parameters of the surface of the runway or taxiway; and
a communications unit arranged to transfer data derived from the detection unit from the apparatus to a remote server, wherein
the apparatus is arranged to advance along the one or more rails and transfer data representative of one or more parameters of the surface to a remote server.

2. An apparatus according to claim 1, wherein the drive unit comprises one or more wheels arranged to provide or assist rolling motion of the apparatus along the one or more rails.

3. An apparatus according to claim 1, wherein the drive unit comprises a maglev module arranged to provide magnetic levitation of the apparatus against the one or more rails.

4. An apparatus according to claim 1, wherein the drive mechanism comprises a winch, arranged to engage a guide rope provided on the one or more rails to provide motion of the apparatus with respect to the one or rails.

5. An apparatus according to claim 1, wherein the drive mechanism comprises a clamp for engaging the one or more rails so as to lock the apparatus engaged in contact or proximity with the one or more rails.

6. An apparatus according to claim 1, wherein the communications unit comprises a transceiver arranged to wirelessly transfer data between the apparatus and the remote server.

7. An apparatus according to claim 1, wherein the communications unit is arranged to transfer data between the apparatus and the remote server by transmitting signals through the rails on which the drive unit is mounted.

8. An apparatus according to claim 6, wherein the transceiver of the communications unit is operable to receive instruction information from a remote server, and the communications unit is arranged, in use, to communicate the instruction information to one or more of the drive unit and the detection units.

9. An apparatus according to claim 1, wherein the one or more sensors of the detection unit comprises a friction meter arranged to measure and output data representative of a friction level of the runway surface.

10. An apparatus according to claim 9, wherein the friction meter comprises a friction measurement wheel arranged, in use, to be in contact with the surface.

11. An apparatus according to claim 9, wherein the friction meter comprises an optical module arranged to provide a measurement of the runway surface friction.

12. An apparatus according to claim 1, wherein the detection unit further comprises an FOD sensor arranged, in use, to detect the presence of foreign object debris, on the runway surface and/or on the one or more rails.

13. An apparatus according to claim 12, wherein the FOD sensor comprises one or more sensors selected from the group comprising: an x-ray sensor, a visible light camera, an infrared camera, a Lidar detector, a thermal image camera and a metal detection sensor.

14. An apparatus according to claim 1, wherein the detection unit comprises a transmissometer operable to measure an ambient attenuation of light and output data representative of runway visibility.

15. An apparatus according to claim 1, wherein the detection unit further comprises a terrain sensor operable to scan and detect terrain surrounding the apparatus.

16. An apparatus according to claim 15, wherein the terrain sensor comprises a LIDAR module arranged to scan and detect the surroundings of the apparatus, and output data representative of the surroundings of the apparatus.

17. An apparatus according to claim 1, wherein the drive unit is arranged to use data derived from the terrain sensor to navigate and autonomously effect movement of the apparatus along the one or more rails.

18. An apparatus according to claim 1, wherein the one or more sensors comprise a thermal imaging sensor configured to generate a map of the heat of the surface of the runway.

19. An apparatus according to claim 1, wherein the one or more sensors comprise a runway light detector, arranged to detect the presence of runway lights and check the proper functioning of lights on the runway.

20. An apparatus according to claim 1, further comprising a maintenance unit arranged, in use, to perform maintenance operations on the surface of the runway or taxiway.

21. An apparatus according to claim 20, wherein the maintenance unit further comprises a wildlife repeller arranged, in use, to repel wildlife proximal to the surface.

22. An apparatus according to claim 20, wherein the maintenance unit further comprises a fire extinguisher, comprising an extinguishing agent tank and an extinguisher nozzle, operable to controllably release an extinguishing agent from the extinguishing agent tank.

23. An apparatus according to claim 1, wherein the detection unit further comprises one or more fire detectors.

24. (canceled)

25. (canceled)

26. (canceled)

27. (canceled)

28. (canceled)

29. (canceled)

30. (canceled)

31. (canceled)

32. A multifunctional aerodrome maintenance apparatus for monitoring runway and taxiway conditions and remotely reporting the status of the runway or taxiway, the apparatus comprising:
a drive unit arranged to mount one or more rails to provide movement of the apparatus along the one or more rails;
a multifunctional detection and/or maintenance unit configured to detect parameters of the surface of the runway or taxiway or perform maintenance operations on the runway or taxiway; and
a communications unit arranged to transfer data derived from the detection unit from the apparatus to a remote server, wherein
the apparatus is arranged to advance along the one or more rails and transfer data representative of one or more parameters to a remote server.

33. A multifunctional aerodrome maintenance apparatus according to claim 32, wherein the multifunctional detection and/or maintenance unit comprises a plurality of functional modules, each configured to perform a function of detection or maintenance on the surface of the runway or taxiway.

34. A multifunctional aerodrome maintenance apparatus according to claim 32, wherein the multifunctional detection and/or maintenance unit comprises two or more selected from a group comprising:
a laser, sound, and/or thermal camera to find and scare wildlife;
a friction meter or infrared laser to measure friction on the surface of the runway or taxiway a LIDAR camera to detect foreign objects, FOD;
a camera to measure a strength of lights to detect defects;
a light washer to wash runway lights;
a camera technology to inspect pavement cracks for further analysis on when to improve the pavement;
visibility, air temperature and/or ground temperature sensors; and,
a thermal camera to map runway surface conditions.
